(19) United States
(12) Patent Application Publication
(10) Pub. No.: US 2014/0069951 A1
(43) Pub. Date: Mar. 13, 2014

(54) ELECTRIC APPARATUS WITH SENSOR DETECTION SYSTEM

(71) Applicant: EnOcean GmbH, Oberhaching (DE)

(72) Inventors: Frank Schmidt, Altkirchen (DE); Jim O'Callaghan, Cottonwood Heights, UT (US); Eugene You, Salt Lake City, UT (US)

(73) Assignee: EnOcean GmbH, Oberhaching (DE)

(21) Appl. No.: 14/078,162

(22) Filed: Nov. 12, 2013

Related U.S. Application Data
(63) Continuation of application No. PCT/EP2012/055008, filed on Mar. 12, 2012.
(60) Provisional application No. 61/485,400, filed on May 12, 2011.

(51) Int. Cl. A47K 10/32; G05B 1/01

(52) U.S. Cl. CPC A47K 10/32; G05B 1/01
USPC 221/13; 340/3.1

(57) ABSTRACT

The invention pertains to an electric apparatus with a sensor detection system for detecting the presence and/or movement of human beings within a predetermined proximity of the electric apparatus, the sensor detection system generating an electric output signal for controlling the electric apparatus. The sensor detection system comprises at least two sensors wherein a first sensor is designed for monitoring gross parameters of presence and/or movement and wherein a second sensor is designed for monitoring precise parameters of presence and/or movement. The second sensor is electrically post-connected to the first sensor such that the second sensor is activated depending on a first sensor signal of the first sensor upon gross detection of presence and/or movement by the first sensor, and generating a second sensor signal upon precise detection of presence and/or movement, the second sensor signal constituting the output signal of the sensor detection system.

### RELATED APPLICATIONS

This application is a continuation of International Application Number PCT/EP2012/055008, filed Mar. 12, 2012, which claims the benefit of U.S. Provisional Patent Application No. 61/485,400, filed May 12, 2011. The entire contents of the foregoing applications are hereby incorporated herein by reference.

### DESCRIPTION

The invention pertains to an electric apparatus with a sensor detection system for detecting presence and/or movement of human beings within a predetermined proximity of the electric apparatus, the sensor detection system generating an electric output signal for controlling the electric apparatus.

Such an electric apparatus has become widespread in the field of application of automated dispenser systems for dispensing predetermined portions of a sanitary product. The automated dispenser systems may comprise for example automatic faucet valves, toilet flush valves, urinal flush valves, automated soap dispensers, towel dispensers and other devices that monitor precise presence of a human being.

An electric apparatus of the kind mentioned above must employ a detection system that quickly and reliably determines when a human being comes near to the electric apparatus and comes with its body or its extremities in close proximity to the apparatus. Thereby, the detector must perform well across a wide range of environmental conditions, as there are different human conditions, e.g. hand sizes, skin colours, clothing colours or skin humidity, different sink construction conditions such as ceramic, metal, porcelain, plastic as well as different textures, reflections and colours, and finally different air conditions in sanitary facilities, e.g. a wide range of temperature and humidity ranges.

The optimal sensing technologies for such precise sensing are typically high energy consuming. As a result, these technologies require either an external power wire or batteries that require periodic changing.

Therefore, it is an object of the invention to provide an electric apparatus of the type mentioned above with a reduced overall power consumption of the sensor detection system which nevertheless maintains reliability of sensing.

It is another object of the invention to provide an electric apparatus with a reduced overall power consumption of the sensor detection system such that the electric apparatus can be designed as self-powered system without any need of an external power wire or batteries.

Pursuant to these objects, the present invention provides an electric apparatus with a sensor detection system of the type mentioned above wherein the sensor detection system comprises at least two sensors, a first sensor being designed for monitoring gross parameters of presence and/or movement and a second sensor being designed for monitoring precise parameters of presence and/or movement, the second sensor being electrically post-connected to the first sensor such that the second sensor is activated depending on a first sensor signal of the first sensor upon gross detection of presence and/or movement by the first sensor and generating a second sensor signal upon precise detection of presence and/or movement, the second sensor signal constituting the output signal of the sensor detection system.

Such an electric apparatus, therefore, provides a dual-sensor detection system, wherein one low-power consuming sensor monitors gross movement in the area of the apparatus. This low-power consuming sensor serves as a switch, turning on the second high-power sensor upon detection of an object. The high-power sensor then monitors for precise parameters, e.g. a person's hands within sufficient proximity of the electric apparatus before starting for example the release of a sanitary product.

Hence, the first sensor is always in a sensing condition for detecting objects, the second sensor being only in a sensing condition if the first sensor has detected movement or appearance within a certain proximity. Therefore, the first sensor works with a higher false-alarm probability and less reliability concerning its sensing results than the second sensor but consequently shows less power consumption than the second sensor. The high energy consuming second sensor for precise and reliable sensing is only momentarily active when crucial results have to be obtained, the average power consumption of the whole system being reduced significantly. This enables much longer battery life or alternatively power to be provided by the system itself, i.e. the system provides energy harvesting functionality. Furthermore this enables energy cost-saving operation of such an electric apparatus.

Preferably, the gross parameters of presence and/or movement constitute the appearance of an object within the proximity of the electric apparatus according to a first resolution and/or sensitivity, whereby the precise parameters of presence and/or movement constitute movement patterns concerning changes in the direction and/or distance of an object with regard to the electric apparatus according to a second resolution and/or sensitivity, the second resolution and/or sensitivity being higher than the first resolution and/or sensitivity.

That means, the first sensor is monitoring gross parameters according to a first resolution and/or sensitivity, thereby scanning the near proximity of the electric apparatus in order to detect the appearance of an object. The first sensor can, for example, be designed as passive infrared sensor (PIR) that works on basis of the pyroelectric effect, wherein a sensor signal is triggered according to the changing of temperature in the near proximity. As such a sensor provides a good sensitivity across the sensor field, this kind of sensor is useful for detecting movements of objects crossing or traversing the sensor field.

However, the second sensor is designed for detecting precise movement patterns according to a second resolution and/or sensitivity as they arise during changes in the direction or the distance of an object with regard to the electric apparatus. Therefore, the second sensor not only comprises a certain sensitivity for the appearance of an object within its proximity but primarily senses how an object is changing its position with regard to the electric apparatus. The second sensor can be designed as an infrared (IR) or radar sensor which has become widespread in the use of light barriers, photoelectric reflective barriers or electric eyes.

For example, if a human being comes near to the electric apparatus, the first sensor will trigger a first sensor signal according to the appearance of the human being within the proximity of the apparatus. Thereupon, the second sensor will firstly become active and secondly will detect precise movement patterns of the human being. If the human being comes with its extremities, e. g. its hands, within a close proximity of the electric apparatus, the second sensor will quickly detect this change in distance, thereby consequently activating, for example, dispensing means of the electric apparatus for dispensing a sanitary product such as soap, towels, water or the like.

Preferably, the sensor detection system comprises a sensor control unit being electrically connected between the first sensor and the second sensor for switching the second sensor on or off depending on a change of the first sensor signal. With use of such a sensor control unit, the second sensor is not directly dependent on the first sensor signal but becomes indirectly dependent on the first sensor signal. That means, upon detection of any appearance of an object by the first sensor, the first sensor signal is transmitted to the sensor control unit, the sensor control unit processing and/or amplifying the first sensor signal values for controlling and switching the second sensor. It is conceivable and suitable that the sensor control unit has Schmitt-Trigger function with hysteresis for switching the second sensor only if the first sensor signal significantly changes between clearly distinct values. The Schmitt-Trigger function has the advantage, the second sensor remaining in a stable condition even if the first sensor signal is unsteady between certain boundaries due to sensing variations.

Preferably, the second sensor signal being generated by the second sensor is orthogonal to the first sensor signal. In this context, orthogonal means any mathematical orthogonal relationship between these signals. For example, orthogonality of the signals can be obtained by arranging the two sensors in an orthogonal manner such that the signal vectors of the first and second sensor signals are orthogonal, i.e. their scalar product becomes zero. But orthogonality can also be obtained, the two sensor signals having different frequencies such that they are uncorrelated, i.e. the integral of their product over a time period results in zero. The advantage of the two sensor signals being orthogonal to each other lies in a minimization of an influence of the two sensors to each other such that different signal parameters can nearly independently be observed by the two sensors.

Preferably, the sensor control unit comprises a first timer, the second sensor being automatically deactivated upon its activation after a predetermined time period of the first timer has elapsed, independent of whether the first sensor signal will decline again or not. According to this feature, the power consumption of the high energy consuming second sensor can significantly be reduced as the second sensor is only activated for a shortened predetermined period. However, it is conceivable that the second sensor is automatically deactivated after the second sensor signal—optionally for a certain time—has exceeded a predetermined signal value, thereby indicating that the second sensor has detected respective parameter values in an adequate manner.

Preferably, the predetermined time period of the first timer is adjustable to time of day and/or frequency of use. That means, the sensing duration and the corresponding power consumption can be adapted to the situations in which the electric apparatus and its sensor detection system are used. If the electric apparatus is, for example, a dispenser system in a public sanitary facility, the predetermined time period can be extended in times when a lot of people are frequently using the electric apparatus and can be shortened in times when few people are using the electric apparatus.

Preferably each of the two sensors is designed for monitoring a corresponding area of proximity. Preferably, the respective areas of proximity are distinct from each other. Each sensor is sensing a respective area, the area of the first sensor for example being greater than the area of the second sensor. This is suitable for detecting any appearance or presence of an object in the first area by the first sensor and consequently for detecting precise parameters in a smaller second area by the second sensor. In this context, therefore, distinct means a difference of the two areas of proximity with regard to their expansion and orientation in the three-dimensional space. Nevertheless, it is also conceivable that the two areas of proximity are similar to each other.

Preferably, the electric apparatus is an automated dispenser system for use in sanitary facilities, comprising dispensing means for releasing predetermined portions of a sanitary product. As mentioned above, the use of a sensor detection system in accordance with such an automated dispenser system has become widespread.

Preferably, the electric apparatus comprises a dispenser control unit for controlling the dispensing means depending on the output signal of the sensor detection system. The dispenser control unit comprises for example a microcontroller unit for controlling an actuator which delivers the sanitary product, for example a valve, pump or roller motor.

Preferably, the dispenser control unit comprises a second timer, the dispensing means being automatically deactivated upon its activation after a predetermined time period of the second timer has elapsed. By use of this second timer, the dispenser control unit controls the amount of sanitary product being released by the dispensing means. After the time period of the second timer has elapsed, the dispenser control unit shuts down the actuator, i.e. closes the valve or stops the pump or roller motor. It is also conceivable, that the dispensing means are deactivated upon change of the second sensor signal. For example, this would be suitable in situations when an electric soap dispensing system releases soap as long as a person is holding their hands under a spout of the soap dispensing system, the second sensor continuously sensing the hands under the spout until the person removes their hands from the soap dispensing system. However, the automatic timer-controlled deactivation of the dispensing means has the advantage of cost-saving release of the respective sanitary product.

Preferably, the electric apparatus comprises an energy harvesting system converting at least one of the energy sources light, heat, flow, translation, rotation or vibration into electrical energy to power the electric apparatus. As the power consumption can be significantly reduced by interrupting the high power consumption of the second sensor as the second sensor is only activated upon detection by the first sensor, the electric apparatus can be designed as a self-powered apparatus. For example, the flow of water in a urinal can be transmitted into electrical energy by use of an electromagnetic generator. The electrical energy then powers the electric apparatus and its sensor detection system as well as other electronic components like dispensing means or the dispenser control unit. Beside this possible energy harvesting method, any of the above-mentioned energy sources can be used to power the electric apparatus.

Preferably, the energy harvesting system comprises a thermoelectric element converting a thermal gradient into electrical energy. By use of the so-called Seebeck effect, the thermoelectric element generates a voltage due to the thermal gradient. This forms a relatively easy and effective energy harvesting method, the voltage being used to power the whole system.

In the following, the invention is described in more detail with the aid of some embodiments depicted in several figures.

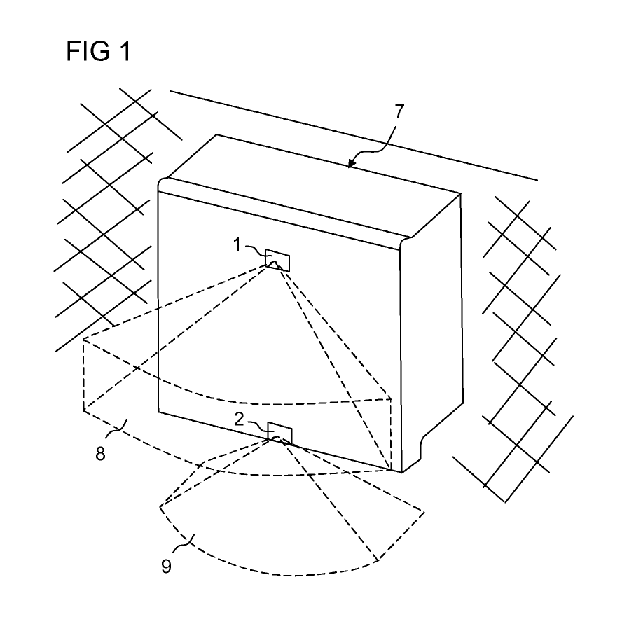

FIG. 1 shows a perspective view of a dispenser system.

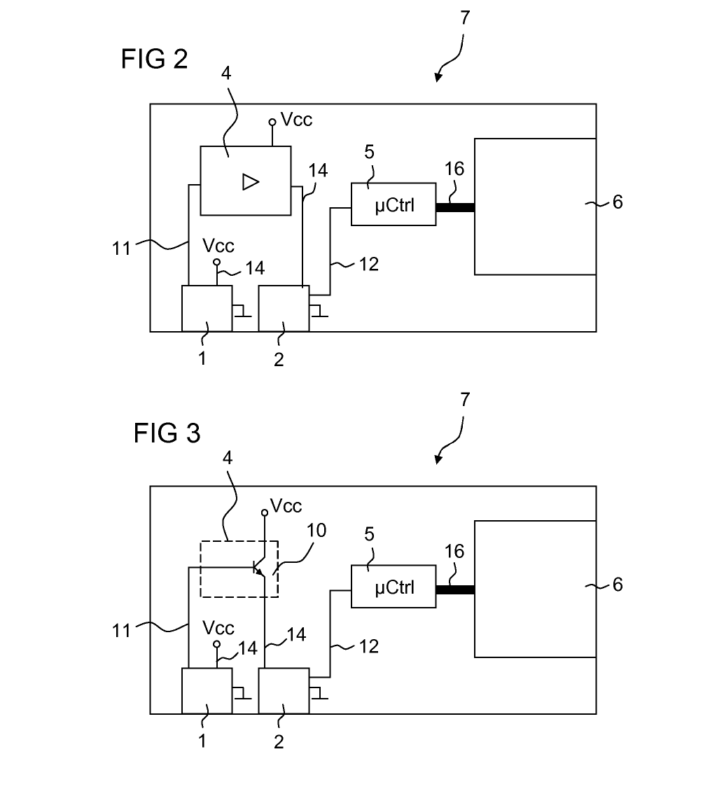

FIG. 2 shows a schematic block diagram of a first embodiment of a dual-sensor system used in the dispenser system.

FIG. 3 shows a detailed view of the embodiment of FIG. 2.

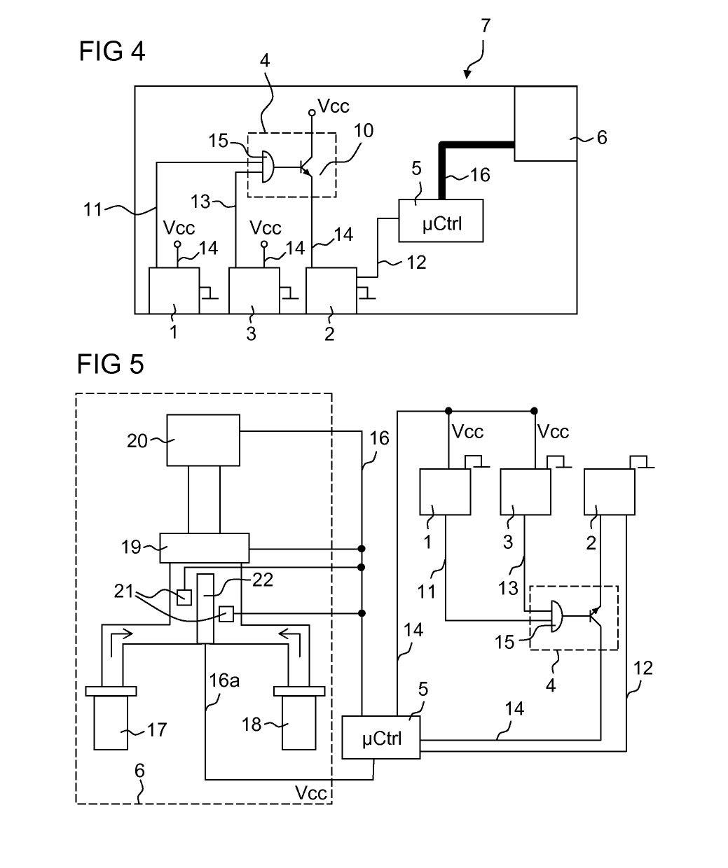

FIG. 4 shows a schematic block diagram of another embodiment of a sensor system used in the dispenser system.

FIG. 5 shows a detailed view of an embodiment of FIG. 4.

FIG. 1 shows a dispenser system 7, e.g. a soap or towel dispenser, releasing predetermined portions of soap or a predetermined number of paper towels when persons are holding their hands under the release of the dispenser system 7. The dispenser system 7 comprises two sensors, a first sensor 1 and a second sensor 2, the two sensors 1 and 2 being designed for detecting appearance and movement of a person coming near to the dispenser system 7.

In particular, the first sensor 1 monitors a first area of proximity 8, thereby sensing the appearance of an object within the first area of proximity 8. The first sensor 1 comprises a first resolution and/or sensitivity and is, for example, designed as a passive infrared (PIR) sensor, measuring a change of the temperature according to a change of the thermal radiation of objects within the near proximity of the first sensor 1. According to the embodiment of FIG. 1, the first sensor 1 is arranged so as to monitor gross movements of objects coming near to the front side of the dispenser system 7 within the first area of proximity 8.

The second sensor 2 monitors a second area of proximity 9 and is designed for sensing precise movement patterns concerning changes in the direction and/or distance of an object within the second area of proximity 9. The second sensor 2 is, for example, designed as an infrared (IR), IR-grid or radar sensor, working with a second resolution and/or sensitivity. Therefore, the second sensor is especially designed for sensing precise and fine parameters, e.g. movements of a person's hands being brought within the near proximity of the release of the dispenser system 7 within the second area of proximity 9.

According to the basic idea of such a dispenser system 7, the first sensor 1 monitors with its first resolution and/or sensitivity the gross movement or appearance of persons approaching the dispenser system 7 within the first area of proximity 8. The first sensor 1 is always active but comprises a small amount of power consumption. The second sensor 2, however, monitors with a second resolution and/or sensitivity being higher than the first resolution and/or sensitivity of the first sensor 1 much more precise movements. For example, the second sensor 2 detects a person's hands, thereby determining whether a person who has neared the dispenser system 7 has the tendency to bring their hands under the release of the dispenser system 7 within the second area of proximity 9 such that predetermined portions of a sanitary product of the dispenser system 7 are to be released. Therefore, the second sensor 2 is much more energy consuming than the first sensor 1 and consequently consumes much more power.

Unlike the first sensor 1, the second sensor 2 is not always active but is sensing only if the first sensor 1 has detected an object within the first area of proximity 8. The first sensor 1 alone, according to its position and sensing behaviour, is not able to yield an adequate result for activating dispensing means of the dispenser system 7. But with the aid of the second sensor 2 and its ability to monitor precise movement in the region under the dispenser system 7 within the second area of proximity 9, not only the appearance but precise movement behaviour of an object can be detected.

A so-called dual-sensor detection system of the type mentioned above comprises the first sensor 1 being always active and the second sensor 2 being only active upon gross detection of presence and/or movement by the first sensor 1. The first sensor 1 works with a higher false-alarm probability than the second sensor 2 but consumes much less power than the second sensor 2. As the second sensor is only activated upon positive detection of the first sensor 1, the power consumption of the whole dual-sensor detection system is significantly reduced, nevertheless yielding a sensing result that guarantees safe and justified activation of the dispenser system 7.

The function of the dual-sensor detection system is depicted in FIG. 2. The first sensor 1 being supplied by a respective supply voltage line 14 delivers, via a first sensor signal line 11, first sensor signal values to a sensor control unit 4 upon gross detection of an object's appearance within its proximity.

As a result, the sensor control unit 4 then activates the second sensor 2 by connecting the second sensor 2 to the supply voltage via the respective supply voltage line 14 being arranged between the sensor control unit 4 and the second sensor 2. After that, the second sensor 2 is monitoring for precise parameters within the proximity of the dispenser system 7, thereby monitoring precise movement patterns of small objects like hands, fingers or parts of clothing. If the second sensor 2 senses such movement patterns, it delivers second sensor signal values via the second sensor signal line 12 to a dispenser control unit 5 which in this embodiment is designed as a microcontroller unit. The dispenser control unit 5 sums, amplifies and processes the second sensor signal values, thereby generating an actuator signal for controlling dispensing means 6 of the dispenser system 7. Thus, the dispensing means 6, e.g. an actuated valve, roller motor or pump, is activated upon detection by the first and second sensors 1 and 2 and is controlled by the dispenser control unit 5 via a system management-but (SM-bus) 16.

If the first sensor 1 triggers in a first step a first sensor signal and if consequently the second sensor 2 triggers in a second step a downstream second sensor signal, the dispenser control unit 5 will activate the dispensing means 6 for releasing a sanitary product of the dispenser system 7. After a predetermined time period has elapsed or after yielding a justified result, the second sensor 2 will be cut off from the supply voltage, the sensor control unit 4 cutting supply voltage line 14 thereby stopping the second sensor 2 in fulfilling its duties. As a result, the second sensor 2 will no longer consume power, thereby being inactive until the sensor control unit 4 activates the second sensor 2 again. However, the first sensor 1 remains in an active condition, furthermore sensing the near proximity.

As the second sensor 2 is post-connected to the first sensor 1, the second sensor 2 is only activated if the first sensor 1 triggers a first sensor signal upon detection of an object in the proximity of the dispenser system 7. If the object is being removed from the dispenser system 7, the first sensor signal will fall below a predetermined limit, thereby deactivating again the second sensor 2. But it is also conceivable to provide a timer-controlled deactivation of the second sensor 2 such that the second sensor 2 is automatically deactivated after a predetermined time period has elapsed. In addition or as an alternative thereto, the second sensor 2 can also be automatically deactivated after the second sensor signal has exceeded a predetermined signal value indicating that adequate parameter values have been determined. According to these measures, the power consumption of the dispenser system 7 is significantly reduced.

According to the embodiment illustrated in FIG. 3, the sensor control unit 4 can simply be realized with a switching element 10, which in this embodiment is a bipolar transistor. With the basis of the transistor 10 connected to the first sensor signal line 11, the emitter of transistor 10 connected to the supply voltage line 14 of the second sensor 2 and the collector of transistor 10 connected to the supply voltage Vcc, the second sensor 2 is only connected to the supply voltage Vcc and therefore activated if the first sensor 1 yields a current on the first sensor signal line 11, thereby controlling the basis of the transistor 10. In this situation, the collector-emitter passage of the transistor 10 yields a collector-emitter current supplying the second sensor with electric energy via the supply voltage line 14. In the other case, the collector-emitter passage of the transistor 10 remains blocked, the second sensor 2 being cut off from the supply voltage Vcc. According to this configuration, the second sensor 2 is only activated upon triggering a first current signal by the first sensor 1 via the first sensor signal line 11 controlling the transistor 10.

FIG. 4 shows another embodiment of a dispenser system 7, now providing the first and second sensors 1 and 2 and an additional third sensor 3 being connected parallel to the first sensor 1. The third sensor 3, as well as the first sensor 1, is always active, sensing with low power consumption a respective area of proximity in order to yield a third sensor signal which can be compared to the first sensor signal of the first sensor 1. The arrangement of the third sensor 3 in parallel with the first sensor 1 has the advantage of reducing the false-alarm probability in order to only activate the post-connected second sensor 2 in justified and truly determined situations.

According to the embodiment of FIG. 4, the first and third sensor signals of first and third sensor signal lines 11 and 13, are compared by a logical AND-gate 15 that is pre-connected to the switching element 10, i.e. the bipolar transistor, of the sensor control unit 4. Hence, the second sensor 2 will only be activated if the first and the third sensors 1 and 3 trigger first and third sensor signals.

For example, it is conceivable to arrange the third sensor 3 geometrically orthogonal to the first sensor 1 such that the near proximity of the dispenser system 7 is monitored by the first and third sensors 1 and 3, yielding two independent sensor signals. Thereby, it is also conceivable to arrange the second sensor 2 in such a manner that the second sensor signal is orthogonal to the first sensor signal and/or the third sensor signal. In this context, orthogonal means any mathematical orthogonality of the signals such that the signals are uncorrelated and independent from each other.

After the first and third sensor signals have been compared by the AND-gate 15 of the sensor control unit 4 and positively checked for a relevant signal value, the second sensor 2 that is post-connected to the first and third sensors 1 and 3, is activated and connected to the supply voltage Vcc via the transistor 10 and its supply voltage line 14. If thereupon the second sensor 2 triggers a positive second sensor signal with a certain amplitude, this signal will be transmitted via the second sensor signal line 12 to the dispenser control unit 5 which finally generates an activation signal for the dispensing means 6 via the SM-bus 16.

FIG. 5 shows a detailed embodiment of a sensor detection system in connection with dispensing means 6 of a dispenser system 7 according to FIG. 4. In the embodiment of FIG. 5, the first, second and third sensors 1, 2, and 3 are triggering and delivering their respective sensor signal values in the manner as described with reference to FIG. 4. In FIG. 5 the dispenser control unit 5 now controls the dispensing means 6 which here is designed as an automated thermostatic mixing valve. Hence, the dispensing means 6 comprises a hot water line 17 and a cold water line 18 which are both mixed by an automated mixing valve 19. The hot water line 17 and cold water line 18 may be part of an automated faucet system in a sanitary facility. The hot water line 17 may duct hot water with a temperature of, for example, 65° C., thereby providing an adequate protection against Legionella. The cold water line 18 may duct, for example, water with a temperature of 10° C. The hot and cold water lines 17 and 18 are mixed together by the automated mixing valve 19 providing increased safety against scalding and increased user comfort because of the control of the water temperature. Finally, the mixed water is released by an automated faucet valve 20, persons having the possibility to wash their hands with the mixed water.

As the sensor detection system, comprising the first, second and third sensors 1, 2, and 3, is significantly reduced concerning its power consumption due to the interrupted activation of the high-performance second sensor 2, the whole system can be designed as a self-powered system. That means, the electric energy supplying the electric components of the dispenser system is generated by the system itself. This can be achieved by providing a thermoelectric element 22 between the hot water and cold water side within the dispensing means 6, in detail between the hot water line 17 and the cold water line 18. The thermoelectric element 22 according to this embodiment, works with regard to the so-called Seebeck effect. That means, due to the temperature gradient between the hot water line 17 and cold water line 18, a voltage proportional to the temperature difference is effected at both ends of the thermoelectric element 22. The voltage serves as electric energy to power the system, whereby the voltage is gripped via the energy harvesting line 16a by the dispenser control unit 5. Thereby it is suitable to provide the dispenser control unit 5 with an energy storage device, i.e. a high-capacitance energy storage, for storing the electric energy created by the thermoelectric element.

The electric energy is furthermore transmitted as supply voltage Vcc via the supply voltage line 14 to first, second and third sensors 1, 2, and 3. Other components such as the automated mixing valve 19 and the automated faucet valve 20 as well as two temperature sensors 21 are supplied via the SM-bus 16 which comprises, besides supply voltage lines, also control lines for bi-directional transmitting of control signals from the dispenser control unit 5 to the components 19, 20 and 21.

The temperature sensors 21 transmit respective sensor signals to the dispenser control unit 5 which indicate the corresponding temperatures at the hot water line 17 and cold water line 18 of the thermostatic mixing valve. By aid of the measured temperature values, the dispenser control unit 5 controls the mixing temperature of the automated mixing valve 19.

Thus, the dispenser control unit 5 can control at which temperature the automated mixing valve 19 mixes the hot water line 17 and cold water line 18 and further controls the opening of the automated faucet valve 20 depending on the sensor signals, especially the second sensor signal of the second sensor 2 which relates to an operational movement of persons holding their hands under the spout of a faucet for washing their hands.

The basic idea of the invention is the design of a dual-sensor detection system with one or more low-power sensors, monitoring gross parameters in the proximity of the dispenser system and a post-connected high-power sensor, monitoring precise parameters within the proximity of a release of the dispenser system. By activating the high-power sensor only upon detection of any appearance of an object near the dispenser system by the low-power sensors, the overall power consumption can be significantly reduced. As a consequence, the system can be designed as a self-powered energy harvesting system generating the necessary electrical energy itself without any use of external power wires or batteries.

The invention is not restricted to the embodiments depicted in the FIGS. 1 to 5. Hence, it is conceivable that the sensor detection system comprises several low-power sensors and several post-connected high-power sensors which perform sensing with regard to respective resolutions and/or sensitivities. The arrangement of the sensors in the dispenser system can be adapted to the sensing conditions and the environmental conditions according to the use of the dispenser system. The dispenser system can comprise any variations of dispensing means, like water faucets, urinals, toilet flush valves, automated soap dispensers or towel dispensers. Thereby, the dispenser system can comprise any variations of energy harvesting systems, converging at least one of the energy sources light, heat, flow, translation, rotation or vibration into electrical energy to power the dispenser system. The embodiments depicted in the Figures are exemplary embodiments which schematically show the principle of the invention without restricting the invention to the specified embodiments.

### LIST OF REFERENCE SYMBOLS

1 first sensor
2 second sensor
3 third sensor
4 sensor control unit
5 dispenser control unit
6 dispensing means
7 dispenser system
8 first area of proximity
9 second area of proximity
10 switching element
11 first sensor signal line
12 second sensor signal line
13 third sensor signal line
14 supply voltage line
15 AND-gate
16 system management bus
16a energy harvesting line
17 hot water
18 cold water
19 automated mixing valve
20 automated faucet valve
21 temperature sensor
22 thermoelectric element
Vcc supply voltage

1. Electric apparatus with a sensor detection system for detecting presence and/or movement of human beings within a predetermined proximity of the electric apparatus, the sensor detection system generating an electric output signal for controlling the electric apparatus,
characterized in that
the sensor detection system comprises at least two sensors,
a first sensor being designed for monitoring gross parameters of presence and/or movement and
a second sensor being designed for monitoring precise parameters of presence and/or movement,
the second sensor being electrically post-connected to the first sensor such that the second sensor is activated depending on a first sensor signal of the first sensor upon gross detection of presence and/or movement by the first sensor, and
generating a second sensor signal upon precise detection of presence and/or movement, the second sensor signal constituting the output signal of the sensor detection system.

2. Electric apparatus according to claim 1,
characterized in that
the gross parameters of presence and/or movement constitute the appearance of an object within the proximity of the electric apparatus according to a first resolution and/or sensitivity and
the precise parameters of presence and/or movement constitute movement patterns concerning changes in the direction and/or distance of an object with regard to the electric apparatus according to a second resolution and/or sensitivity,
the second resolution and/or sensitivity being higher than the first resolution and/or sensitivity.

3. Electric apparatus according to claim 1,
characterized in that
the sensor detection system comprises a sensor control unit being electrically connected between the first sensor and the second sensor for switching the second sensor on or off depending on a change of the first sensor signal.

4. Electric apparatus according to claim 1,
characterized in that
the second sensor signal being generated by the second sensor is orthogonal to the first sensor signal.

5. Electric apparatus according to claim 3,
characterized in that
the sensor control unit comprises a first timer, the second sensor being automatically deactivated upon its activation after a predetermined time period of the first timer has elapsed.

6. Electric apparatus according to claim 5,
characterized in that
the predetermined time period of the first timer is adjustable to time of day and/or frequency of use.

7. Electric apparatus according to claim 1,
characterized in that
each of the two sensors is designed for monitoring a corresponding area of proximity.

8. Electric apparatus according to claim 7,
characterized in that
the respective areas of proximity are distinct from each other.

9. Electric apparatus according to claim 1,
characterized in that
the electric apparatus is an automated dispenser system for use in sanitary facilities, comprising dispensing means for releasing predetermined portions of a sanitary product.

10. Electric apparatus according to claim 9,
characterized in that
the electric apparatus comprises a dispenser control unit for controlling the dispensing means depending on the output signal of the sensor detection system.

11. Electric apparatus according to claim 10,
characterized in that
the dispenser control unit comprises a second timer, the dispensing means being automatically deactivated upon its activation after a predetermined time period of the second timer has elapsed.

12. Electric apparatus according to claim 1, characterized in that
the electric apparatus comprises an energy harvesting system converting at least one of the energy sources light, heat, flow, translation, rotation or vibration into electrical energy to power the electric apparatus.

13. Electric apparatus according to claim 12,
characterized in that
the energy harvesting system comprises a thermoelectric element converting a thermal gradient into electrical energy.
